(19) United States
(12) Patent Application Publication
(10) Pub. No.: US 2025/0044999 A1
(43) Pub. Date: Feb. 6, 2025

(54) INFORMATION PROCESSING APPARATUS, APPLICATION EXECUTION CONTROL METHOD, AND NON-TRANSITORY COMPUTER-READABLE STORAGE MEDIUM

(71) Applicant: CASIO COMPUTER CO., LTD., Tokyo (JP)

(72) Inventor: Kenichi NARUSE, Tokyo (JP)

(21) Appl. No.: 18/792,094

(22) Filed: Aug. 1, 2024

(30) Foreign Application Priority Data
Aug. 4, 2023 (JP) 2023-127426

(51) Int. Cl. G06F 3/12

(52) U.S. Cl. CPC G06F 3/121; G06F 3/123; G06F 3/1243

(57) ABSTRACT

An information processing apparatus includes a communication device configured to, in response to receiving an operation to start an application program, communicate with an external apparatus and obtain a management file, the management file including control information associated with a version of the application program; and at least one processor configured to, in a case where the control information associated with the version of the application program to be started is included in the management file obtained through the communication device, perform a control related to start processing of the application program based on the control information associated with the version of the application program to be started.

### CROSS-REFERENCE TO RELATED APPLICATIONS

This application claims priority to and the benefit of Japanese Patent Application No. 2023-127426 filed on Aug. 4, 2023, the entire contents of which are incorporated herein by reference.

### TECHNICAL FIELD

The present disclosure relates to an information processing apparatus, an application execution control method, and a non-transitory computer-readable storage medium.

### BACKGROUND

Recent information processing apparatuses are adapted to make it possible to obtain application programs to be executed on the information processing apparatuses via a communication network such as the Internet. Some information processing apparatus of this type is adapted, for the purpose of improving security, to start a user application when it is confirmed by an integrity-guaranteed kernel that the user application has not been falsified (for example, refer to JP2010-182196A).

### SUMMARY

An information processing apparatus according to an illustrative embodiment of the present disclosure includes a communication device configured to, in response to receiving an operation to start an application program, communicate with an external apparatus and obtain a management file, the management file including control information associated with a version of the application program; and at least one processor configured to, in a case where the control information associated with the version of the application program to be started is included in the management file obtained through the communication device, perform a control related to start processing of the application program based on the control information associated with the version of the application program to be started.

### BRIEF DESCRIPTION OF THE SEVERAL VIEWS OF THE DRAWING

FIG. 1 is a block diagram showing an example of a configuration of an information processing system including an information processing apparatus according to an illustrative embodiment.

FIG. 2 is a block diagram showing an example of a configuration of the information processing apparatus according to the illustrative embodiment.

FIG. 3 shows an example of a configuration of a management file.

FIG. 4 shows a specific example of the management file.

FIG. 5 is a diagram showing a first example of a provision method for providing information on a Web page.

FIG. 6 is a diagram showing a second example of the provision method for providing information on a Web page.

FIG. 7 is a diagram showing a third example of the provision method for providing information on a Web page.

FIG. 8 is a flowchart illustrating an example of processing that is performed by the information processing apparatus according to the illustrative embodiment before starting a print application.

FIG. 9 is a flowchart illustrating an example of processing in which the information processing apparatus according to the illustrative embodiment starts a print application.

FIG. 10 is a diagram showing an example of variable values and meanings thereof used in the flowcharts illustrated in FIGS. 8 and 9.

### DETAILED DESCRIPTION

Hereinafter, illustrative embodiments of the present disclosure will be described with reference to the drawings. Note that, in the following description, as an example of an application program that is executed by an information processing apparatus, an application program (hereinafter, referred to as “label creation application”) that can cause the information processing apparatus to perform a variety of processing related to controlling an operation of a printing apparatus configured to perform printing on a to-be-printed medium having a tape shape will be used. For example, when executed by the information processing apparatus, the label creation application can cause the information processing apparatus to perform processing such as creating print data including information on characters, figures and the like to be printed on the to-be-printed medium, and transmitting the created print data to a printing apparatus.

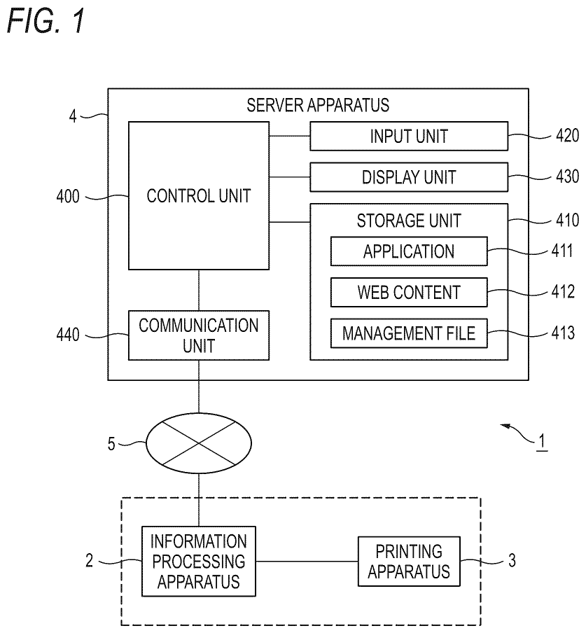

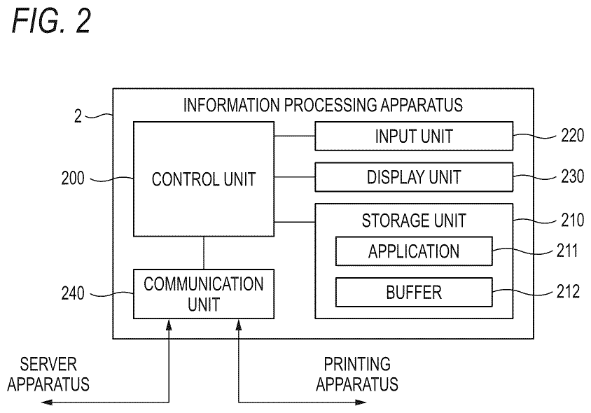

FIG. 1 is a block diagram showing an example of a configuration of an information processing system including an information processing apparatus according to an illustrative embodiment. FIG. 2 is a block diagram showing an example of a configuration of the information processing apparatus according to the illustrative embodiment. An information processing system 1 illustrated in FIG. 1 includes an information processing apparatus 2, a printing apparatus 3, and a server apparatus 4.

The information processing apparatus 2 may be an apparatus that can execute a label creation application including instructions for causing the information processing apparatus 2 to execute various processing related to controlling an operation of the printing apparatus 3 and can also communicate with the printing apparatus 3 and a communication network 5 such as the Internet. The information processing apparatus 2 may be a computer with a communication function, such as a personal computer or a smart phone. The information processing apparatus 2, which may be a computer, includes a control unit 200, a storage unit 210, an input unit 220, a display unit 230, and a communication unit 240, from a functional configuration perspective, as illustrated in FIG. 2.

The control unit 200 controls an operation of the information processing apparatus 2. The control unit 200 controls the operation of the information processing apparatus 2 by executing various instructions included in a program such as an operating system (which is abbreviated as OS) or the label creation application described above. The instructions included in the program may also be called commands, orders, directions, and the like. The functions of the control unit 200 may be provided by an arithmetic processing unit such as a CPU (which stands for Central Processing Unit) that executes a program of the label creation application.

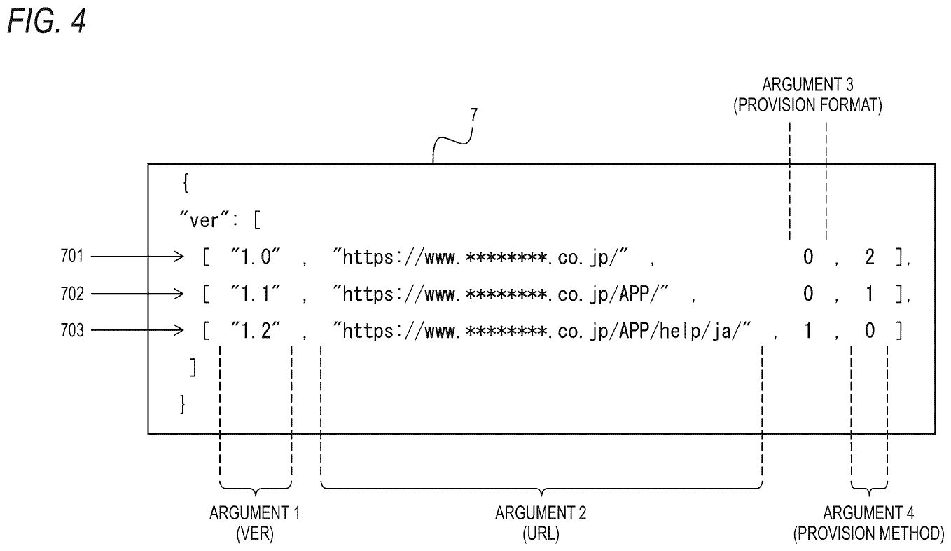

The storage unit 210 stores a program that is executed by the control unit 200, data referred to during execution of the program, and various other data. The storage unit 210 includes an application storage area 211 and a buffer 212. The application storage area 211 is, for example, an area that stores the label creation application described above. The label creation application stored in the application storage area 211 includes a program including various instructions that are executed by the information processing apparatus 2 and data such as characters and figures to be printed on a to-be-printed medium. The buffer 212 is a storage area that temporarily stores, for example, print data being created or created using the label creation application, a management file 7 (see FIG. 4) obtained from the server apparatus 4, and the like. The functions of the storage unit 210 are provided by a read only memory (which is abbreviated as ROM) and a random access memory (which is abbreviated as RAM). Some of the functions of the storage unit 210 are provided by a cache built into an arithmetic processing unit such as a CPU, for example. Some of the functions of the storage unit 210 may be provided by, for example, an auxiliary storage device such as a hard disk drive (which is abbreviated as HDD) or a solid state drive (which is abbreviated as SSD). Some of the functions of the storage unit 210 may be provided by, for example, a portable storage medium that can be freely attached to and detached from the information processing apparatus 2 and can also be read by the information processing apparatus 2, such as a storage device with a USB (which stands for Universal Serial Bus) terminal and a card-type storage device. The portable storage medium may include, for example, an optical disc such as a compact disc (which is abbreviated as CD), a digital versatile disc (which is abbreviated as DVD), and a Blu-ray (registered trademark) disc.

The input unit 220 accepts an input of various types of information related to operations of the information processing apparatus 2 (for example, an input of character information, selection of data, and the like). The display unit 230 displays various types of information related to operations of the information processing apparatus 2. The functions of the display unit 230 are provided by, for example, a dot matrix-type flat panel display such as a liquid crystal monitor. The functions of the input unit 220 may be provided by a position detection device disposed overlapping a display area of a liquid crystal monitor, which may be the display unit 230, for example. That is, the functions of the input unit 220 and the display unit 230 of the information processing apparatus 2 may be provided by a touch panel display in which an input device and a display device are integrated. Some of the functions of the input unit 220 may be provided by, for example, an input device such as a keyboard and a mouse, a camera, a microphone, a button switch, and the like.

The communication unit 240 communicates with the server apparatus 4 via the communication network 5, and with the printing apparatus 3. Communication between the communication unit 240 and the communication network 5 is performed by, for example, either wired communication using a transmission cable such as a LAN (which stands for Local Area Network) cable or wireless communication in conformity to a wireless communication standard such as Wi-Fi (registered trademark). Communication between the communication unit 240 and the communication network 5 may also be performed using, for example, a mobile phone line. Communication between the communication unit 240 and the printing apparatus 3 is performed by, for example, either wireless communication in conformity to wireless communication standards such as Wi-Fi, Bluetooth (registered trademark), and BLE (which stands for Bluetooth Low Energy (registered trademark)) or wired communication using a transmission cable such as a USB cable.

The hardware configuration of the information processing apparatus 2 according to the present illustrative embodiment may be any configuration that can provide the functions described above with reference to FIG. 2, and is not limited to a specific hardware configuration. For example, some or all of the functions of the control unit 200 and the storage unit 210 of the information processing apparatus 2 may be provided by a hardware device in which a processor such as a CPU and a storage device such as a ROM and a RAM are integrated. Some or all of the functions of the control unit 200 and the storage unit 210 of the information processing apparatus 2 may be provided by, for example, a field programmable gate array (which is abbreviated as FPGA), an application specific integrated circuit (which is abbreviated as ASIC), or the like. Additionally, the functions of the control unit 200 of the information processing apparatus 2 may be provided by a plurality of arithmetic processing units, such as a combination of a CPU and a digital signal processor (which is abbreviated as DSP).

The information processing apparatus 2 communicates with the server apparatus 4 through, for example, the communication unit 240 and obtains from the server apparatus 4 a label creation application that can be used to control the printing apparatus 3, and the like. Additionally, the information processing apparatus 2 obtains a management file 7, which will be described below, from the server apparatus 4 when an operation to start the label creation application is performed. The server apparatus 4 may be, for example, a Web server that provides various information regarding the printing apparatus 3 and the label creation application, a label creation application, and the like. The server apparatus 4 may be a computer that is communicatively connected to the communication network 5 and communicates with various apparatuses including the information processing apparatus 2 via the communication network 5. From the functional configuration perspective, the server apparatus 4 includes a control unit 400, a storage unit 410, an input unit 420, a display unit 430, and a communication unit 440, as illustrated in FIG. 1.

The control unit 400 controls an operation of the server apparatus 4. The control unit 400 controls the operation of the server apparatus 4 by executing various instructions included in an OS program and an application program. The functions of the control unit 400 may be provided by an arithmetic processing unit such as a CPU that executes a program.

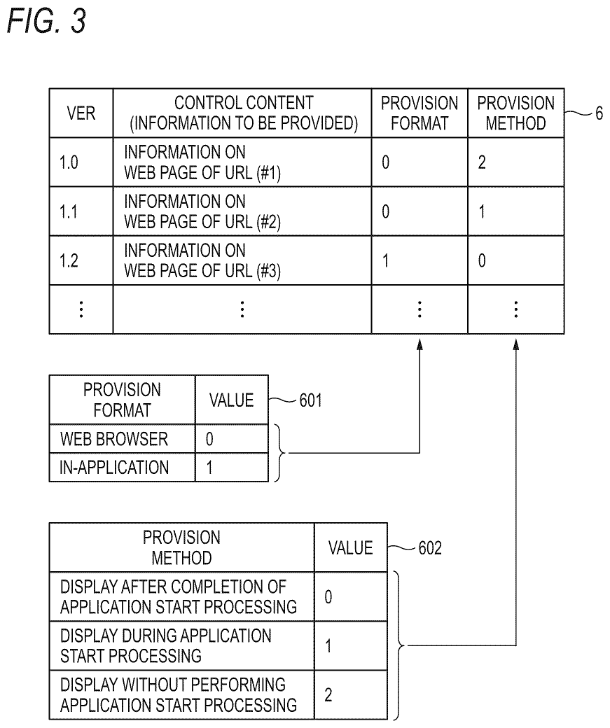

The storage unit 410 stores a program that is executed by the control unit 400, data referred to during execution of the program, and various other data. The storage unit 410 includes an application storage area 411, a Web content storage area 412, and a management file storage area 413. The application storage area 411 is an area that stores the above-described label creation application to be provided to the information processing apparatus 2, for example. In the application storage area 411, for example, a plurality of label creation applications of different versions (in other words, a plurality of versions of a single type of label creation application specified by a name or the like) are stored. The plurality of label creation applications stored in the application storage area 411 may include, for example, those having different models of corresponding printing apparatuses 3. The Web content storage area 412 is an area that stores contents for providing information regarding the printing apparatus 3 and the label creation application using, for example, a Web browser. The contents stored in the Web content storage area 412 include, for example, contents related to the specifications and operating methods of the printing apparatus 3, and contents related to the respective functions and operating methods of a plurality of label creation applications of different versions. The management file storage area 413 is an area that stores a management file that manages processing to be performed by the information processing apparatus 2 when the label creation application is started in the information processing apparatus 2. The management file stored in the management file storage area 413 includes, for example, information in which a version of a label creation application is associated with a content of processing that is performed by the information processing apparatus 2 when an operation to start the label creation application of the version is performed, as described below with reference to FIGS. 3 and 4. The functions of the storage unit 410 are provided by, for example, a ROM and a RAM, an auxiliary storage device (for example, an HDD, an SSD, and the like), a portable storage medium, and the like.

The input unit 420 accepts an input of various types of information related to operations of the server apparatus 4 (for example, an input of character information, selection of data, and the like). The functions of the input unit 420 are provided by an input device such as a keyboard and a mouse, for example. Some of the functions of the input unit 420 may be provided by, for example, a microphone, a camera, a button switch, and the like. The display unit 430 displays various information regarding operations of the server apparatus 4, and the like. The functions of the display unit 430 are provided by, for example, a dot matrix-type flat panel display such as a liquid crystal monitor. Some of the functions of the input unit 420 and the display unit 430 of the server apparatus 4 may be provided by, for example, a touch panel display in which an input device and a display device are integrated.

The communication unit 440 communicates with the information processing apparatus 2 via the communication network 5. Communication between the communication unit 440 and the communication network 5 is performed by, for example, either wired communication using a transmission cable such as a LAN cable or wireless communication in conformity to a wireless communication standard such as Wi-Fi.

The hardware configuration of the server apparatus 4 according to the present illustrative embodiment can be any configuration that can provide the functions described above with reference to FIG. 1, and is not limited to a specific hardware configuration. For example, the functions of the control unit 400 of the server apparatus 4 may be provided by a plurality of arithmetic processing units, such as a combination of a CPU and a digital signal processor (which is abbreviated as DSP). Additionally, the functions of the server apparatus 4 described above may be provided by a plurality of apparatuses communicatively connected without being limited to a single apparatus. For example, the information processing system 1 may have a configuration in which, instead of the single server apparatus 4, a first apparatus storing a label creation application, a second apparatus storing Web contents, and a third apparatus storing a management file are communicatively connected to the communication network 5 directly or via another apparatus.

When an operation to start the label creation application stored in the storage unit 210 of the information processing apparatus 2 according to the present illustrative embodiment is performed, the information processing apparatus 2 accesses the server apparatus 4 and obtains a management file before starting start processing of the label creation application. The term “start processing” in the present specification refers to processing that is performed by the information processing apparatus 2 in order to operate the information processing apparatus 2 to create print data or transmit the print data to the printing apparatus 3. As described above, the management file obtained by information processing apparatus 2 includes information in which a version of a label creation application is associated with a content of processing that is performed by the information processing apparatus 2 when an operation to start the label creation application of the version is performed.

FIG. 3 shows an example of a configuration of a management file. FIG. 4 shows a specific example of the management file.

FIG. 3 illustrates a management table 6 showing information included in the management file in a table format. “VER” in the management table 6 is information that identifies a version of the label creation application that is a management target. In FIG. 3, three versions of the label creation application, “1.0”, “1.1”, and “1.2”, are shown as an example. The information identifying the version of the label creation application is not limited to information in a specific format. The term “version” in the present specification refers to information that distinguishes a plurality of label creation applications that are different in terms of specifications of the label creation applications, functions effective (available) when the label creation application is executed, date and time of release (publication), and the like, and may include differences in specifications, functions, and the like expressed by terms such as “revision” or “build.” For example, version “1.1” in FIG. 3 may include “1.1.0” and “1.1.1”, or may be subdivided into “1.1.0” and “1.1.1”. Note that the management table 6 may not include one or more versions among all versions of the label creation application that is the management target. For example, if the label creation application of version “1.3” does not have information to be provided to a user, such as malfunctions or precautions for use, “VER” may not include “1.3”.

“Control content” in the management table 6 is information indicating contents of control that is performed by the control unit 200 of the information processing apparatus 2 when an operation to start the label creation application is performed on the information processing apparatus 2. In FIG. 3, as an example of control that is performed by the control unit 200, control for providing information on a Web page associated with a version of the label creation application is shown. URL (#1), URL (#2), and URL (#3) in the management table 6 of FIG. 3 are intended to be URL (which stands for Uniform Resource Locator) of the Web page. According to the management table 6 in FIG. 3, when the version of the label creation application that the information processing apparatus 2 is trying to start is “1.0,” the control unit 200 of the information processing apparatus 2 provides information on a Web page of URL (#1) to the user. Additionally, when the version of the label creation application that the information processing apparatus 2 is trying to start is “1.1,” the control unit 200 of the information processing apparatus 2 provides information on a Web page of URL (#2) to the user. Note that the control performed by the information processing apparatus 2 is not limited to the control for providing the information on a Web page described above, and may be other controls. Instead of the URL, a URI (which stands for Uniform Resource Identifier) or the like may be used.

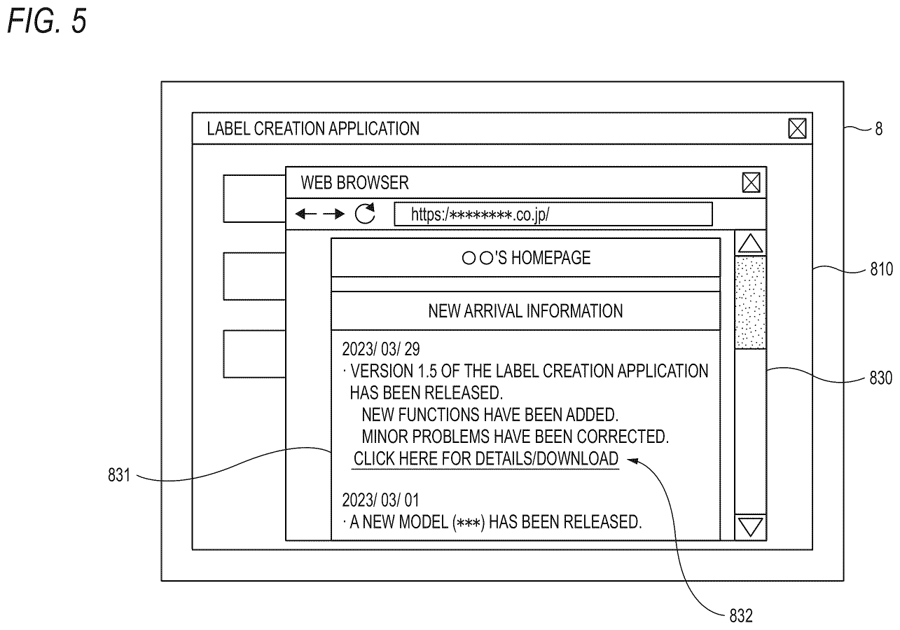

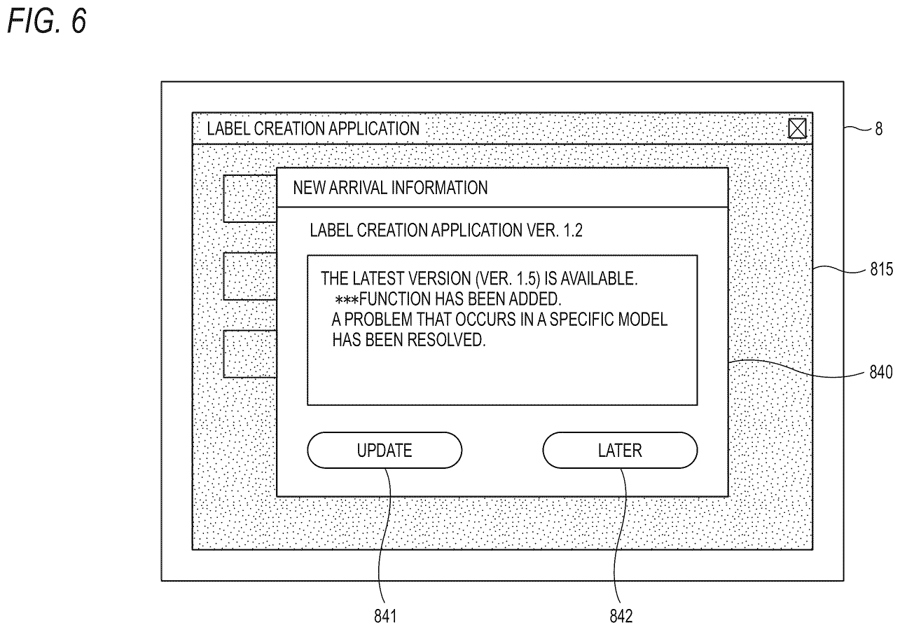

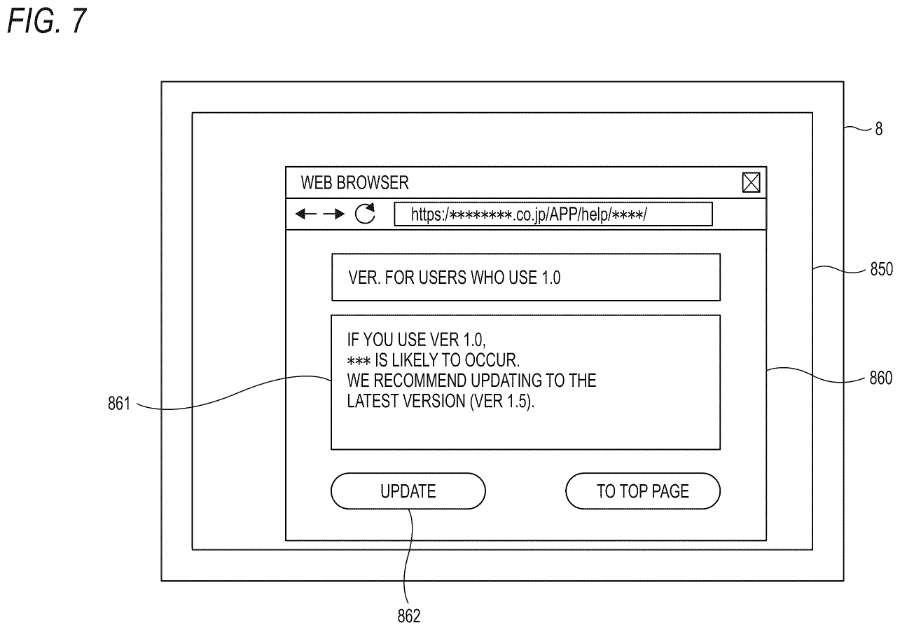

The “provision format” in the management table 6 is information indicating a format when providing information on a Web page associated with a version of the label creation application. The provision format in the management table 6 of FIG. 3 is set in accordance with a definition table 601 shown in FIG. 3, for example. The definition table 601 shows two formats for providing information on a Web page: “Web browser” and “In-application.” “Web browser” is a format that displays and provides information on a Web page on a Web browser, which is an application program different from the label creation application (see FIGS. 5 and 7, for example). “In-application” is a format that displays and provides information on a Web page on a screen of the label creation application such as a dialog generated by the label creation application (see FIG. 6, for example). The provision format in the management table 6 is set to “0” when providing the information by a Web browser, and set to “1” when providing the information by a screen of the label creation application, in accordance with the definition table 601. Note that in all versions, when information on a Web page is provided by a Web browser, the “provision format” may be omitted from the management table 6.

The “provision method” in the management table 6 is information indicating a relationship between providing (displaying) information on a Web page associated with a version of the label creation application and the start processing of the label creation application. The provision method in the management table 6 of FIG. 3 is set in accordance with a definition table 602 shown in FIG. 3, for example. The definition table 602 shows, as the relationship between providing (displaying) information on a Web page and the start processing of the label creation application, three relationships of “display after completion of application start processing,” “display during application start processing,” and “display without performing application start processing.” In the case of “display after completion of application start processing”, the information processing apparatus 2 displays information on a Web page after the start processing of the label creation application is completed. In the case of “display during application start processing”, the information processing apparatus 2 pauses the start processing during the start processing of the label creation application and displays information on a Web page. In the case of “display without performing application start processing,” the information processing apparatus 2 displays information on a Web page without performing the start processing of the label creation application. The provision method in the management table 6 is set to “0” when displaying the information after completion of the application start processing, is set to “1” when displaying the information during the application start processing, and is set to “2” when displaying the information without performing the application start processing, in accordance with the definition table 602. The “provision method” in the management table 6 is not limited to the separation method based on the three relationships described above. Note that the provision format in the version in which the provision method is “2” (i.e., display without performing application start processing) is automatically set to “0”, indicating provision by a Web browser.

The information processing apparatus 2 obtains, as a management file corresponding to the management table 6 illustrated in FIG. 3, a management file 7 in which, for example, a character string as illustrated in FIG. 4 is described. The management file 7 is an example of a JSON file written in a JSON format. In the management file 7 of FIG. 4, four pieces of information (“VER”, “Control content”, “Provision format”, and “Provision method”) for one row in the management table 6 is described as four arguments (array elements) from argument 1 to argument 4 in one set of square brackets, which is one array showing information for one version. In the management file 7, three arrays: an array 701 representing information associated with a version “1.0,” an array 702 representing information associated with a version “1.1,” and an array 703 representing information associated with a version “1.2” are described. In the management file 7, arrays of other versions may also be additionally described.

In one array (for example, array 701), “VER” in the management table 6 is described in the argument 1, and “control content” in the management table 6 is described in the argument 2. When the control content is a control for displaying the above-described Web page, a URL of the Web page to be displayed is described in the argument 2. “********” in the URL shown as an example of the argument 2 in FIG. 4 is turned characters, and a combination of characters (including a numerical value and a symbol) described, the number of characters, and the like may be arbitrary. In the argument 3, a numerical value representing the “provision format” in the management table 6 is described. The argument 3 of the management file 7 in FIG. 4 conforms to the definition table 601 illustrated in FIG. 3, and is set to “0” when displaying the information on a Web browser, and set to “1” when displaying the information as a screen of the label creation application. In the argument 4, a numerical value representing the “provision method” in the management table 6 is described. The argument 4 of the management file 7 in FIG. 4 conforms to the definition table 602 illustrated in FIG. 3, and is set to “0” when displaying the information after completion of the application start processing, set to “1” when displaying the information during the application start processing”, and set to “2” when displaying the information without performing the application start processing.

For example, the array 701 of the management file 7 in FIG. 4 shows that when the version of the label creation application that the information processing apparatus 2 is trying to start is “1.0”, a Web page of a URL “https://www.********.co.jp/” is displayed on a Web browser by the information processing apparatus 2, and the start processing of the label creation application is not executed.

Note that the management file 7 in FIG. 4 is only an example of the management file corresponding to the management table 6 described above with reference to FIG. 3 and provided to the information processing apparatus 2. The description format in the management file 7, such as a version, a control content, a provision format, and a provision method, is not limited to a specific format.

FIG. 5 is a diagram showing a first example of a provision method for providing information on a Web page. FIG. 6 is a diagram showing a second example of the provision method for providing information on a Web page. FIG. 7 is a diagram showing a third example of the provision method for providing information on a Web page.

FIG. 5 shows, as a first example of a provision method for providing information on a Web page, an example of a provision method for performing start processing of a label creation application and displaying information on a Web page on a Web browser. In other words, FIG. 5 shows an example of information that is displayed on a display device 8 (display unit 230) of the information processing apparatus 2 when an operation is performed to start the label creation application of a version 1.1 in which the provision format is “0” and the provision method is “1” in the management file 7 described above with reference to FIG. 4.

The display device 8 illustrated in FIG. 5 displays a window 810 of a label creation application and a window 830 of a Web browser arranged in front of the window 810. The window 810 of the label creation application is displayed on the display device 8 at the start of the start processing of the label creation application or during the start processing. The window 830 of the Web browser is displayed during the start processing of the label creation application. When the provision method is “1”, for example, the information processing apparatus 2 pauses (interrupts) the start processing at a point of time when the screen to be displayed first in the start processing of the label creation application is displayed on the display device 8, and starts the Web browser to cause a Web page to be displayed on the window 830.

The label creation application of the version in which the provision method is “1” may be one with a level in which a malfunction does not occur even when the start processing is performed or does not lead to a serious problem even if the malfunction occurs. Therefore, when starting the label creation application of the version in which the provision method is “1”, for example, information with low urgency or low importance, such as new arrival information 831 regarding the label creation application as shown in FIG. 5, is displayed in the window 830 of the Web browser. The new arrival information 831 may include, for example, a link 832 to another Web page that provides detailed information regarding the label creation application. “1” in the provision method may be used, for example, in association with a version of the label creation application in which a certain malfunction may occur when the start processing is completed under certain conditions. For this reason, it is possible to prevent a malfunction from occurring by pausing the start processing of the label creation application and displaying information on a Web page by the Web browser.

When the provision method is “1”, the start processing of the label creation application is paused and the window 830 of the Web browser is displayed. For this reason, when the provision method is “1”, the information processing apparatus 2 resumes the start processing of the label creation application, on condition that an operation of closing the window 830 of the Web browser is performed or a predetermined operation is performed on the window 810 of the label creation application. For example, when the provision method is “1”, text information indicating that the start processing is paused and a button for resuming the start processing may be displayed on the windows 810 of the label creation application.

Note that the display screen illustrated in FIG. 5 may be a screen after completion of the start processing of the label creation application of a version in which the provision method in the management file 7 is “0”. When the start processing of the label creation application is completed, print data may be created or the like by, for example, moving the window 810 of the label creation application to the front of the window 830 of the Web browser and performing an operation on the window 810.

FIG. 6 shows, as a second example of a provision method for providing information on a Web page, an example of a provision method for performing start processing of a label creation application and displaying information on a Web page on a dialog generated by the label creation application. In other words, FIG. 6 shows an example of information that is displayed on the display device 8 (display unit 230) of the information processing apparatus 2 when an operation is performed to start the label creation application of a version 1.2 in which the provision format is “1” and the provision method is “0” in the management file 7 described above with reference to FIG. 4.

The display device 8 illustrated in FIG. 6 displays a window 815 of the label creation application and a dialog 840 arranged in front of the window 815. The window 815 of the label creation application is displayed on the display device 8 as an inactive window at any timing from start to completion of the start processing of the label creation application. “Inactive” in the present specification refers to a state in which an operation on the window 815 is invalid until the dialog 840 is closed. For example, a button for selecting an operation, and the like may be displayed on the window 815 in FIG. 6, but an operation on the button and the like on the window 815 is invalid while the dialog 840 is displayed.

The label creation application of the version in which the provision method is “0” may be one with a level in which a malfunction does not occur even when the start processing is performed or does not lead to a serious problem even if the malfunction occurs. Therefore, when the label creation application of the version in which the provision method is “0” is started, information on a Web page associated with the version can be displayed by the dialog 840 generated by the label creation application. The dialog 840 in FIG. 6 shows, as an example of the information on a Web page regarding the label creation application of a version “1.2”, new arrival information indicating that update to the latest version is possible. The user who sees the dialog 840 can, for example, select whether to execute the update of the label creation application immediately or later. By pressing an “Update” button 841 in the dialog 840, the information processing apparatus 2 may, for example, end the started label creation application and execute the update (version up) of the label creation application. When a “Later” button 842 of the dialog 840 is pressed, the information processing apparatus 2, for example, hides the dialog 840 and activates the window 815 of the label creation application.

Note that the display screen illustrated in FIG. 6 may be a screen that is displayed when the start processing of the label creation application of a version in which the provision method in the management file 7 is “1” is paused. When the start processing of the label creation application is paused, for example, if an operation of pressing the “Later” button 842 of the dialog 840 is performed, the information processing unit 2 hides the dialog 840 and resumes the start processing of the label creation application.

FIG. 7 shows, as a third example of a provision method for providing information on a Web page, an example of a provision method for providing information on a Web page to a Web browser without performing start processing of the label creation application. In other words, FIG. 7 shows an example of information that is displayed on the display device 8 (display unit 230) of the information processing apparatus 2 when an operation is performed to start the label creation application of a version 1.0 in which the provision format is “0” and the provision method is “2” in the management file 7 described above with reference to FIG. 4.

The display device 8 illustrated in FIG. 7 displays a screen 850, which may be called a desktop screen or a home screen, and a window 860 of a Web browser. When the provision method is “2”, the information processing apparatus 2 displays the window 860 of the Web browser without performing the start processing of the label creation application. For this reason, when the provision method is “2”, the window 810 (see FIG. 5) or 815 (see FIG. 6) of the label creation application is not displayed on the display device 8.

In a label creation application of a version in which the provision method is “2”, for example, even if it has not been falsified by a third party, a malfunction may occur when the start processing is performed, and for example, some or all of data stored in the storage unit 210 may be damaged or lost. It is preferable to avoid making the information processing apparatus 2 start the label creation application of a version in which such a start may cause a malfunction. Therefore, the information processing apparatus 2 according to the present illustrative embodiment does not perform the start processing of the label creation application and provides the information on a Web page to the user by the Web browser when the provision method associated with the version of the label creation application being attempted to be started in the management file 7 is “2”. In this case, the information displayed on the window 860 of the Web browser includes, for example, information 861 suggesting that the version of the label creation application that the information processing apparatus 2 is trying to start is a version that is better not to be started, and a button 862 for executing an update (version up) of the label creation application. When an operation of pressing the button 862 is performed, the display of the window 860 transitions to a Web page where the latest version of the label creation application can be downloaded, for example. This makes it possible to avoid a malfunction occurring due to starting the label creation application.

The information on a Web page provided using the management file 7 is not limited to the new arrival information including the update (version up) information of the label creation application as described above with reference to FIGS. 5 to 7, and may also be other information. For example, a Web page for a specific version may be a Web page that lists inquiries from users regarding the label creation application of the version and answers to the inquiries. In addition, for example, a Web page for a specific version may be a Web page that explains specific functions included in the label creation application of the version.

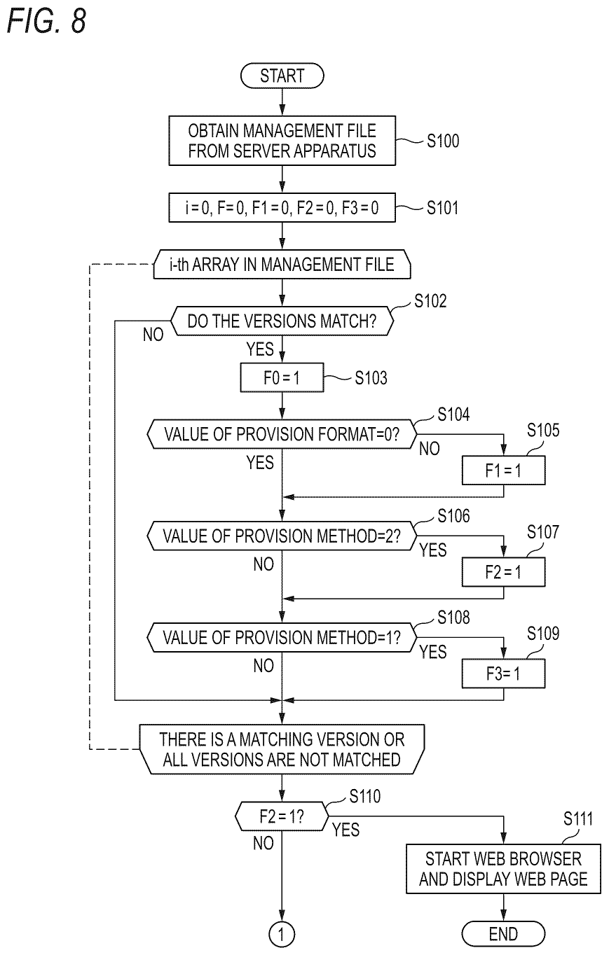

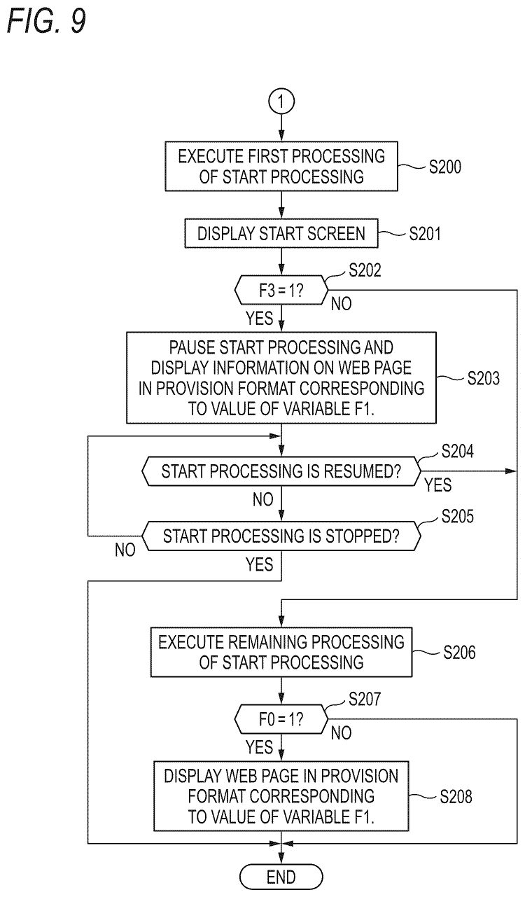

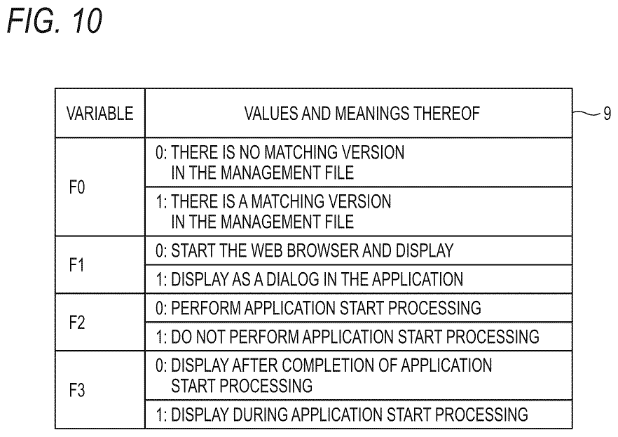

FIG. 8 is a flowchart illustrating an example of processing that is performed by the information processing apparatus according to the illustrative embodiment before starting a print application. FIG. 9 is a flowchart illustrating an example of processing in which the information processing apparatus according to the illustrative embodiment starts a print application. FIG. 10 is a diagram showing an example of variable values and meanings thereof used in the flowcharts illustrated in FIGS. 8 and 9.

When the user performs an operation of starting the label creation application, the information processing apparatus 2 according to the present illustrative embodiment executes processing illustrated in FIG. 8 before starting the label creation application. Then, when it is determined through the processing illustrated in FIG. 8 that the start processing of the label creation application is to be performed, the information processing apparatus 2 performs the processing illustrated in FIG. 9. The start processing of the label creation application in the present specification may be processing for making the information processing apparatus 2 ready to execute processing such as creating print data by the label creation application and changing a setting. In an information processing apparatus to which the present disclosure is not applied, when the user performs an operation for starting the label creation application, the start processing of the label creation application is started without performing processing of steps S100 to S111 illustrated in FIG. 8. The processing of steps S100 to S111 illustrated in FIG. 8 may be called “start preprocessing,” and processing of steps S200 to S208 illustrated in FIG. 9 may be called “start processing.”

When the user of the information processing apparatus 2 performs an operation for starting the label creation application, the information processing apparatus 2 performs start preprocessing including processing of steps S100 to S111 illustrated in FIG. 8. The information processing apparatus 2 first obtains the management file 7 from the server apparatus 4 (step S100), and initializes variables i, F1, F2, F3, and F4 that are used to specify a control content corresponding to the version of the label creation application that the information processing apparatus 2 is trying to start (step S101). Step S100 is performed by the communication unit 240 under control of the control unit 200. Step S101 is performed by the control unit 200. The processing of steps S100 and S101 may be performed in the reverse order or may be performed in parallel.

The variable i is a variable used to identify the version of the label creation application included in the management file 7 (management table 6). In the case where the management file 7 is a JSON format file illustrated in FIG. 4, the variable i is used to identify an array including four array elements of arguments 1 to 4, such as arrays 701 to 703. The variable i is set to i=0 in step S101, for example.

The variable F0 is a variable used to identify whether there is a version in the management file 7 that matches the version of the label creation application that the information processing apparatus 2 is trying to start. For example, as shown in FIG. 10, a variable F0=0 indicates that there is no matching version in the management file 7, and a variable F0=1 indicates that there is a matching version in the management file 7. The variable F0 is set to F0=0 in step S101.

The variable F1 is a variable that indicates the display method of the Web page according to the control content of the management file 7. For example, as shown in FIG. 10, a variable F1=0 indicates display by starting a Web browser, and a variable F1=1 indicates display as a dialog in the application. The variable F1 is set to F1=0 in step S101.

The variable F2 is a variable that indicates whether to perform the start processing illustrated in FIG. 9 following the start preprocessing illustrated in FIG. 8. For example, as shown in FIG. 10, a variable F2=0 indicates that the start processing of the label creation application is to be performed, and a variable F2=1 indicates that the start processing of the label creation application is not to be performed. The variable F2 is set to F2=0 in step S101.

The variable F3 is a variable that indicates whether to pause the start processing illustrated in FIG. 9 midway in order to display information on a Web page, when executing the start processing. For example, as shown in FIG. 10, a variable F3=0 indicates displaying information on a Web page after completion of the start processing (not pausing the start processing), and a variable F3=1 indicates displaying information on a Web page during the start processing (pausing the start processing midway). The variable F3 is set to F3=0 in step S101.

The variables i, F1, F2, F3, and F4 are stored in the buffer 212 of the storage unit 210, for example. The values that the variables i, F1, F2, F3, and F4 can take, and the initial values set to the variables i, F1, F2, F3, and F4 in step S101 are not limited to the above values.

After steps S100 and S101, the information processing apparatus 2 refers to the obtained management file 7 and performs processing for confirming a control content of the information processing apparatus corresponding to the version of the label creation application that the information processing apparatus is trying to start. This processing may be, for example, loop processing including processing of steps S102 to S109, as shown in FIG. 8. The loop processing is performed for each i-th array (version) in the management file 7.

As first processing in the loop processing, the information processing apparatus 2 determines whether a version in an i-th array selected from the management file 7 matches the version of the label creation application that the information processing apparatus is trying to start (step S102). If the versions match (step S102; YES), the information processing apparatus 2 performs processing of step S103 and thereafter. If the versions do not match (step S102; NO), the information processing apparatus 2 determines whether an end condition of the loop processing is satisfied. The end condition of the loop processing is satisfied when the versions match and the processing of step S103 and thereafter is performed (i.e., the case of the variable F0=1), or when the versions of all arrays described in the management file 7 are not matched. If the versions do not match (step S102; NO) and an array that was not selected as the i-th array remains in the management file 7, the information processing apparatus 2 continues to perform the loop processing.

If it is determined in step S102 that the versions match (step S102; YES), the information processing apparatus 2 updates the variable F0 to “1” (step S103). Subsequently, the information processing apparatus 2 determines whether the value of the provision format in the i-th array that is a comparison target in the loop processing being performed currently is “0” (step S104). The value of the provision format in the i-th array is set in accordance with the definition table 601 illustrated in FIG. 3.

If the value of the provision format is not “0” (step S104; NO), the information processing apparatus 2 updates the variable F1 to “1” (step S105), and then continues to determine whether the value of the provision method is “2” (step S106). If the value of the provision format is “0” (step S104; YES), the information processing apparatus 2 skips step S105 and makes a determination in step S106. The value of the provision method in the i-th array is set in accordance with the definition table 602 illustrated in FIG. 3.

If the value of the provision method is “2” (step S106; YES), the information processing apparatus 2 updates the variable F2 to “1” (step S107), and then determines whether the value of the provision method is “1” (step S108). If the value of the provision format is not “2” (i.e., “0” or “1”) (step S106; YES), the information processing apparatus 2 skips step S107 and makes a determination in step S108.

If the value of the provision method is “1” (step S108; YES), the information processing apparatus 2 updates the variable F3 to “1” (step S109) and determines whether the end condition of the loop processing is satisfied. Additionally, if the value of the provision method is not “1” (step S108; NO), the information processing apparatus 2 skips the processing of step S109 and determines whether the end condition of the loop processing is satisfied. As described above, the end condition of the loop processing is the case where the variable F0=1 or the case where the versions of all arrays in the management file 7 do not match the version of the label creation application that the information processing apparatus is trying to start. Accordingly, when the processing of step S103 and thereafter is performed, the information processing apparatus 2 determines that the end condition of the loop processing is satisfied and ends the loop processing.

After ending the loop processing, the information processing apparatus 2 determines whether the variable F2 is “1” (step S110). As described above, when the value of the provision method in the i-th array of the management file 7 is “2”, that is, when the value of the provision method is a value indicating that the start processing of the label creation application is not to be performed, the variable F2 becomes “1” (see FIG. 10). Therefore, when the variable F2=1 (step S110; YES), the information processing apparatus 2 starts the Web browser, displays a Web page associated with the version of the label creation application (step S111), and ends the start preprocessing. As described above with reference to FIGS. 3 and 4, the format for displaying information on a Web page includes a format for displaying the information by a Web browser and a format for displaying the information as a dialog of the label creation application. However, if the start processing of the label creation application is not performed, the information on a Web page cannot be displayed as a dialog of the label creation application. Therefore, when the variable F2=1, the information on a Web page is automatically displayed by the Web browser. By performing step S111, it is possible to suppress starting a normal label creation application that has not been falsified by a third party and may cause a malfunction when started. Therefore, for example, it is possible to prevent data from being damaged or lost due to a malfunction caused by starting the label creation application.

When the variable F2≠1, the information processing apparatus 2 continues to perform start processing according to the flowchart illustrated in FIG. 9. The information processing apparatus 2 first executes first processing of the start processing (step S200) and displays a start screen of the label creation application (step S201). The first processing performed by the information processing apparatus 2 in step S200 may be processing that does not include one or more of processing described as start processing in the label creation application, and is not limited to specific processing. The start screen displayed in step S201 may be, for example, the window 810 of the label creation application shown in FIG. 5.

After steps S200 and S201, the information processing apparatus 2 determines whether the variable F3 is “1” (step S202). As described above with reference to FIG. 10, the value of the variable F3 indicates whether to pause the start processing of the label creation application in order to display the information on a Web page, and the variable F3=1 indicates that the start processing of the label creation application is to be paused midway. Therefore, when the variable F3=1 (step S202; YES), the information processing apparatus 2 pauses the start processing and displays the information on a Web page in the provision format corresponding to the value of the variable F1 (step S203). In step S203, the information processing apparatus 2 displays a screen as illustrated in FIG. 5 when the variable F1=0, and displays a screen as illustrated in FIG. 6 when the variable F1=1. After step S203, the information processing apparatus 2 determines whether an operation to resume the start processing has been performed (step S204), and if the operation to resume has not been performed (step S204; NO), the information processing apparatus determines whether an operation to stop the start processing has been performed (step S205). The operation to resume the start processing may be, for example, an operation to hide the displayed information on a Web page. The operation to stop the start processing may be, for example, an operation to close the window 810 of the label creation application. If it is determined that an operation to stop the start processing has been performed (step S205; YES), the information processing apparatus 2 ends the start processing of the label creation application. If it is determined that an operation to stop the start processing has not been performed (step S205; NO), the information processing apparatus 2 repeats the determination of steps S204 and S205 until the operation to resume the start processing or the operation to stop the start processing is performed.

If it is determined in step S202 that the variable F3≠1 (step S202; NO), or if it is determined that an operation to resume the start processing has been performed (step S204; YES), the information processing apparatus 2 performs the remaining processing of the start processing (step S206). After step S206, the information processing apparatus 2 determines whether the variable F0 is “1” (step S201). As described above, the variable F0 indicates whether there is a version in the management file 7 that matches the version of the label creation application started by the information processing apparatus 2, and the variable F0=1 indicates that there is a matching version in the management file 7. Therefore, if the variable F0=1 (step S207; YES), the information processing apparatus 2 displays the information on a Web page in the provision format corresponding to the value of the variable F1 (step S208) and ends the start processing of the label creation application. If the variable F0=0, it indicates that there is no version in the management file 7 that matches the version of the label creation application started by the information processing apparatus 2, that is, there is no information on a Web page that is displayed in association with the version of the label creation application to be started. Therefore, if the variable F0=0 (step S207; NO), the information processing apparatus 2 skips the processing of step S208 and ends the start processing of the label creation application.

In this way, when the version of the label creation application that the information processing apparatus 2 according to the present illustrative embodiment is trying to start in response to the user's operation is associated with not performing the start processing in the management file 7, the information processing apparatus does not perform the start processing of the label creation application. For this reason, for example, if a malfunction occurs when the label creation application of a specific version is started and may cause damage or loss of data, it is possible to prevent such a malfunction from occurring.

Additionally, the information processing apparatus 2 according to the present illustrative embodiment can display information related to the version of the label creation application to be started even if a malfunction does not occur when the label creation application is started, or even if a malfunction occurs but does not lead to a serious problem. For this reason, for example, information on a malfunction or the like that occurs only when a specific operation is performed under specific conditions can be provided to the user in advance. Therefore, it becomes easier for the user of the label creation application to avoid a malfunction occurring. For example, the information processing apparatus 2 according to the present illustrative embodiment can early notify the user of information unique to a version of the label creation application to be started (for example, an operation method, an unavailable function, a phenomenon that may occur and a countermeasure, and the like), based on the management file 7 obtained from the server apparatus 4. In a label creation application, for example, when print data created with a certain version is transmitted to a specific printing apparatus and printed on a to-be-printed medium, a layout of characters, figures, and the like printed on the to-be-printed medium may differ from a layout of the print data. According to the information processing apparatus 2 of the present illustrative embodiment, the user can know that such a phenomenon occurs when starting the label creation application, and thus can prevent the to-be-printed medium from being wasted due to print failure.

The above illustrative embodiment is a specific example for easy understanding of the present invention, and the present invention is not limited to the illustrative embodiment. The information processing apparatus, the application execution control method, and the non-transitory computer-readable storage medium for recording a program can be variously modified and changed without departing from the scope of the claims.

For example, the information processing apparatus 2 described above with reference to FIGS. 1 and 2 is not limited to a separate apparatus connected to the printing apparatus 3 in the wired or wireless manner, and may be included in the printing apparatus 3. The management file that is obtained by the information processing apparatus 2 may include only an array corresponding to a version of a label creation application that the information processing apparatus 2 starts among the plurality of arrays 701 to 703 associated with each of the plurality of versions illustrated in FIG. 4. Additionally, the application program that the information processing apparatus 2 starts and the management file that is obtained from the server apparatus 4 are not limited to those related to the label creation application described above.

What is claimed is:

1. An information processing apparatus comprising:
a communication device configured to, in response to receiving an operation to start an application program, communicate with an external apparatus and obtain a management file, the management file including control information associated with a version of the application program; and
at least one processor configured to, in a case where the control information associated with the version of the application program to be started is included in the management file obtained through the communication device, perform a control related to start processing of the application program based on the control information associated with the version of the application program to be started.

2. The information processing apparatus according to claim 1,
wherein the control information in the management file includes information indicating whether to perform the start processing of the application program, and
wherein the at least one processor is configured to determine whether to perform the start processing of the application program based on the control information associated with the version of the application program to be started in the management file, before starting the start processing of the application program.

3. The information processing apparatus of claim 1, further comprising:
a display configured to display a screen generated by the application program and a Web page,
wherein the control information in the management file includes a uniform resource locator (URL) of a Web page associated with the version of the application program and information indicating whether to display the Web page by a Web browser or by a screen generated by the application program in a case where the Web page is displayed on the display, and
wherein the at least one processor is configured to:
obtain information on the Web page via the communication device; and
based on the information included in the control information, control the Web page to be displayed on the display by the Web browser or by the screen generated by the application program.

4. The information processing apparatus according to claim 1,
wherein the management file obtained through the communication device includes control information associated with each of a plurality of versions of the application program, and
wherein in a case where the control information associated with the version of the application program to be started is included in the obtained management file, the at least one processor is configured to perform a control related to the start processing of the application program.

5. The information processing apparatus according to claim 1, wherein the application program is configured to cause the information processing apparatus to execute processing of creating print data to be printed on a to-be-printed medium and processing of transmitting the print data to a printing apparatus.

6. An application execution control method to be executed by a computer, the method comprising:
in response to receiving an operation to start an application program,
communicating with an external apparatus and obtaining a management file, the management file including control information associated with a version of the application program; and
in a case where the control information associated with the version of the application program to be started is included in the obtained management file, performing a control related to start processing of the application program based on the control information associated with the version of the application program to be started.

7. A non-transitory computer-readable storage medium having a computer program stored thereon and readable by a computer, the computer program, when executed by the computer, causing the computer to perform:
in response to receiving an operation to start an application program,
communicating with an external apparatus and obtaining a management file, the management file including control information associated with a version of the application program; and
in a case where the control information associated with the version of the application program to be started is included in the obtained management file, performing a control related to start processing of the application program based on the control information associated with the version of the application program to be started.
